(19) United States
(12) Patent Application Publication
(10) Pub. No.: US 2006/0228618 A1
(43) Pub. Date: Oct. 12, 2006

(54) Cathode air baffle for a fuel cell

(76) Inventors: Kevin R. Keegan, Hilton, NY (US); Haskell Simpkins, Grand Blanc, MI (US)

Correspondence Address: DELPHI TECHNOLOGIES, INC., M/C 480-410-202, PO BOX 5052, TROY, MI, 48007, US

(21) Appl. No.: 11/103,719

(22) Filed: Apr. 12, 2005

(51) Int. Cl. H01M 8/02; H01M 8/24; H01M 8/10; H01M 8/12; B32B 3/10; B32B 15/00

(52) U.S. Cl. 429/39; 429/32; 428/131; 428/596

(57) ABSTRACT

A fuel cell stack having perforated baffles disposed within the cathode air flow spaces of the stack for distributing air across the cathode and interconnect surfaces in a predetermined pattern to minimize temperature variations on the cathode surface. A baffle comprises at least one element inclined to the air flow direction and having a pattern of perforations for the passage of air therethrough. A baffle may include one or more additional elements to form, for example, a V shape within the cathode air flow space. The perforations may be in the form of slots, holes, or any other shape as desired. The pattern of perforations may be varied both longitudinally and transversely of the baffle element to modulate air flow both longitudinally and transversely as may be required.

### TECHNICAL FIELD

The present invention relates to fuel cells; more particularly, to devices for controlling air flow through fuel cells; and most particularly, to a baffle for distributing cathode air flowing through a fuel cell.

### BACKGROUND OF THE INVENTION

Fuel cells for combining hydrogen and oxygen to produce electricity are well known. A known class of fuel cells includes a solid-oxide electrolyte layer through which oxygen anions migrate; such fuel cells are referred to in the art as “solid-oxide” fuel cells (SOFCs).

In some applications, for example, as an auxiliary power unit (APU) for an automotive vehicle, an SOFC is preferably fueled by “reformate” gas, which is the effluent from a catalytic hydrocarbon oxidizing reformer. Reformate typically includes amounts of carbon monoxide (CO) as fuel in addition to molecular hydrogen. The reforming operation and the fuel cell operation may be considered as first and second oxidative steps of the liquid hydrocarbon, resulting ultimately in water and carbon dioxide. Both reactions are exothermic, and both are preferably carried out at relatively high temperatures, for example, in the range of 700° C. to 1000° C.

A complete fuel cell stack assembly includes a plurality of components known in the art as interconnects, which electrically connect the individual fuel cells. In a typical SOFC stack assembly, a space is provided for flow of air between each interconnect and the cathode of the adjacent fuel cell. The flowing air serves two purposes: first, of course, is to provide oxygen for the fuel cell reaction with hydrogen; and second is to provide cooling of the stack to prevent overheating from the exothermic reactions of the cells.

The direction of flow of air along the cathode through the cathode air flow space may be considered a first direction of flow. In an SOFC, the direction of flow of reformate through an analogous anode reformate flow space may be in the same direction as the cathode air flow (co-flow), transverse of the cathode air flow (cross-flow), or opposite to the cathode air flow (counter-flow). The entering and exiting temperatures of the cathode air and the reformate may be very different and are affected by the relative flow volumes of the two gases, and will differ significantly depending upon the direction and volume of reformate flow relative to the direction and volume of cathode air flow. As a result, a wide range of temperatures may pertain over the interconnect and cathode surfaces.

It is highly desirable that the distribution of temperatures in directions both along and transverse of the cathode surface be as uniform as possible because the fugacity of oxygen anion through the cathode, and hence the rate of reaction of the cell at the anode side, is a direct function of gas temperature. Preventing cold spots in the cathode will optimize the electric output of the cell. Further, the stack assembly can be subjected to serious and potentially destructive thermal stresses where temperatures along the interconnects and cathodes are highly unbalanced.

What is needed in the art is a means for distributing air flowing through the cathode air flow spaces of a solid oxide fuel cell assembly such that temperature variations of the cathode surfaces are acceptably small, and preferably zero.

It is a principal object of the present invention to minimize temperature variations of the cathode surfaces in a fuel cell stack.

It is a further object of the present invention to increase the electric output of a fuel cell stack.

It is a further object of the present invention to reduce thermal stresses within a fuel cell stack.

### SUMMARY OF THE INVENTION

Briefly described, a fuel cell stack in accordance with the invention is provided with perforated baffles disposed within the cathode air flow spaces of the stack for the distribution of air across the interconnect and cathode surfaces in a predetermined pattern. A baffle comprises at least one element inclined to the air flow direction and having a pattern of perforations for the passage of air therethrough. A baffle may include one or more additional elements to form, for example, a V shape within the cathode air flow space. The perforations may be in the form of slots, holes, or any other shape as desired. The pattern of perforations may be varied as need both longitudinally and transversely of the baffle element to modulate air flow both longitudinally and transversely to provide uniform surface temperatures of the cathodes.

### BRIEF DESCRIPTION OF THE DRAWINGS

The present invention will now be described, by way of example, with reference to the accompanying drawings, in which:

FIG. 1 is an isometric view of a first embodiment of a cathode air flow baffle in accordance with the invention;

FIG. 2 is an elevational cross-sectional view of a portion of a fuel cell stack, showing the baffle shown in FIG. 1 installed in a cathode air flow space;

FIG. 3 is an alternative version of the baffle shown in FIGS. 1 and 2;

FIG. 4 is an enlarged plan view of a perforation pattern for a baffle in accordance with the invention;

FIG. 5 is a view like that shown in FIG. 2, showing a second embodiment of a cathode air flow baffle; and

FIG. 6 is a view like that shown in FIG. 2, showing a third embodiment of a cathode air flow baffle.

### DESCRIPTION OF THE PREFERRED EMBODIMENTS

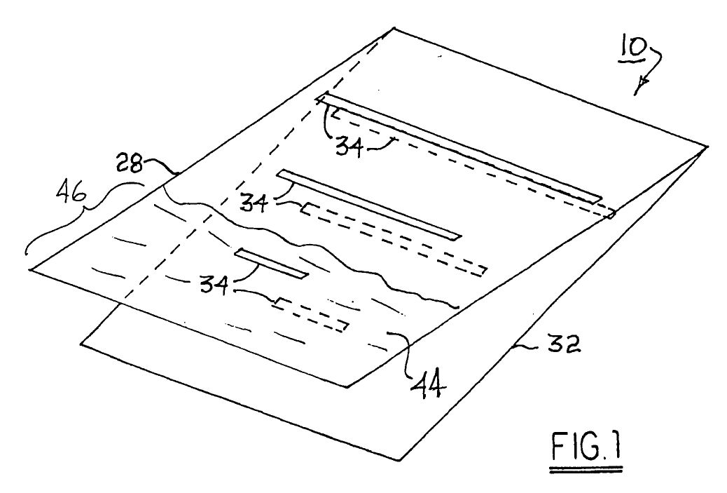

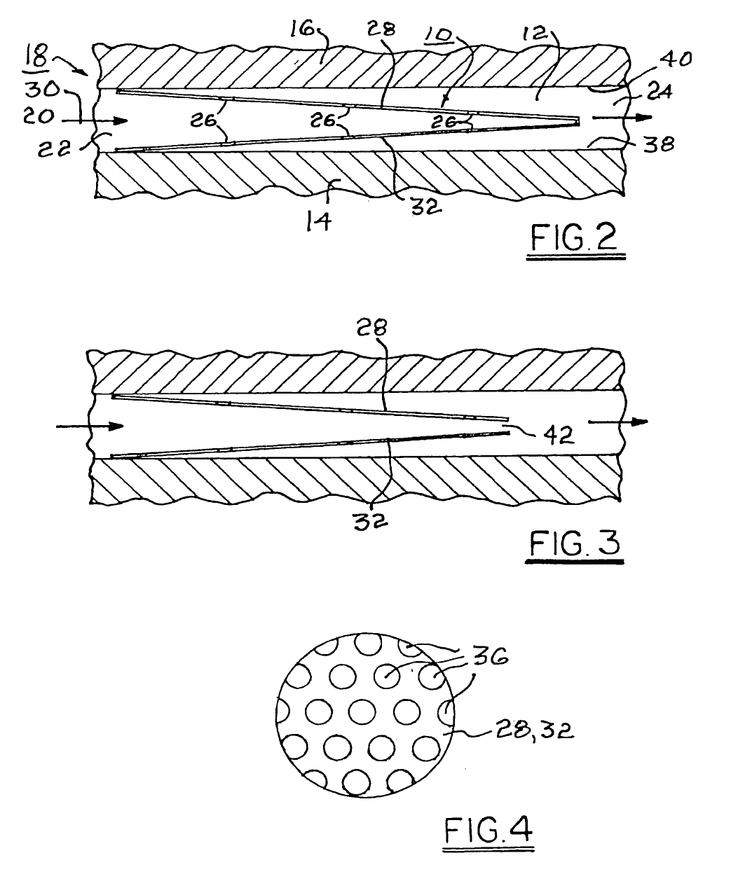

Referring to FIGS. 1 and 2, a baffle 10 is shown for insertion into a cathode air flow space 12 formed between a cathode 14 and an interconnect 16 of a fuel cell stack 18. The individual fuel cells in stack 18 may be of any electrochemical basis, including but not limited to solid oxide fuel cell, proton exchange membrane fuel cell, and direct methanol fuel cell. However, baffle 10 is esepcially suited to use in an SOFC because of the high operating temperatures and large potential thermal stresses. Cathode air 20 enters flow space 12 at an entrance 22 and leaves at exit 24 after at least a portion of air 20 flows through perforations 26 in baffle 10.

A baffle in accordance with the invention comprises at least one element 28 inclined to the direction of flow 30 of cathode air 20 and having a pattern of perforations for the passage of air therethrough. A baffle may include one or more additional elements 32 to form, for example, a V shape within the cathode air flow space as shown in FIGS. 1 and 2. The perforations may be in the form of slots 34 (FIG. 1), holes 36 (FIG. 4), or any other shape as desired. The pattern of perforations may be varied as need both longitudinally and transversely of baffle 10 to modulate air flow both longitudinally and transversely across the surfaces 38,40 of cathode 14 and interconnect 16, respectively, to provide uniform surface temperatures of cathode 14. For example, perforations 34,36 may be arranged in variable size, spacing, and orientation in both the direction 30 of cathode air flow and across the direction of cathode air flow.

Referring to FIGS. 1 through 3, first and second baffle elements 28,32 may be joined, as shown in FIGS. 1 and 2, or not, as shown in FIG. 3, wherein a terminal passage 42 is formed between elements 28,32.

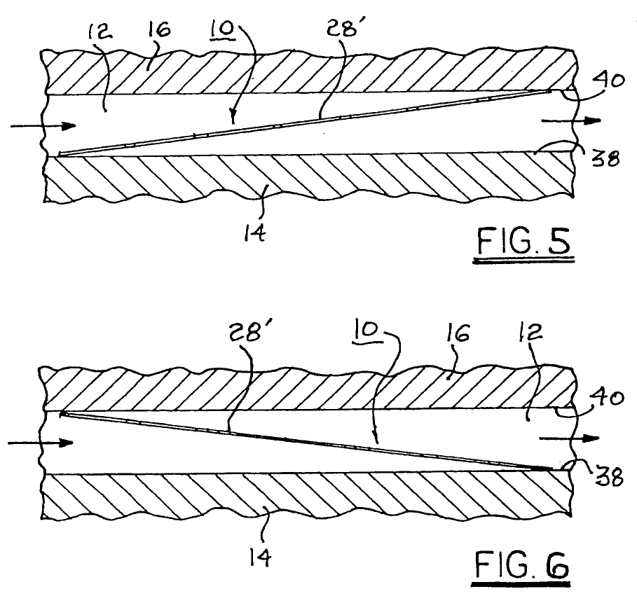

Referring to FIGS. 5 and 6, a baffle 10 in accordance with the invention may comprise a single element 28′ diposed within flow space 12 such that the flow space adjacent interconnect 16 decreases (FIG. 5) or increases (FIG. 6) in volume longitudinally of the baffle. A baffle in accordance with the invention may also be non-parallel with cathode surface 38 and/or interconnect surface 40, as may be desired in order to provide uniform temperatures across cathode surface 38.

A baffle 10 in accordance with the invention may be formed of any suitable material, and is preferably formed of ceramic or by stamping from stainless steel sheeting. Further, because radiative heat transfer between the interconnect and the cathode can be a significant factor at operating temperatures of the fuel cell, baffle 10 may be coated or treated 44 with materials as are known in the art of heat transfer control to adjust the absorptivity and reflectivity of baffle 10 and/or interconnect 16. Such coating or treatment 44 (FIG. 1) may be selectively applied to region 46 of baffle 10, for example, near the entrance to the cathode flow space to reduce heat transfer through high absorptivity and low reflectivity in that region and thereby increase heat transfer farther along the flow space.

While the invention has been described by reference to various specific embodiments, it should be understood that numerous changes may be made within the spirit and scope of the inventive concepts described. Accordingly, it is intended that the invention not be limited to the described embodiments, but will have full scope defined by the language of the following claims.

What is claimed is:

1. A baffle for distributing air within a cathode air flow space of a fuel cell stack, comprising a baffle element disposable in the path of said air flowing through said cathode air flow space and having a pattern of perforations for directing air flowing through said cathode air flow space such that temperature variations across a surface area of a cathode adjacent said baffle are minimized.

2. A baffle in accordance with claim 1 comprising a first element disposable at a first incline to the direction of air flowing through said space.

3. A baffle in accordance with claim 2 comprising a second element disposable at a second incline to the direction of air flowing through said space.

4. A baffle in accordance with claim 3 wherein said first and second elements converge such that said baffle assumes a generally V shape.

5. A baffle in accordance with claim 4 wherein said first and second elements are joined at mutually convegent ends thereof such that said V shape is closed.

6. A baffle in accordance with claim 4 wherein said first and second elements are spaced apart at mutually convegent ends thereof such that said V shape is open.

7. A baffle in accordance with claim 1 wherein said first element is formed of a material selected from the group consisting of stainless steel and ceramic.

8. A baffle in accordance with claim 1 wherein said first element is provided over a region of said baffle element with a coating for modulating reflectivity and absorption of heat of said baffle element in said region.

9. A baffle in accordance with claim 1 wherein the shape of said perforations is selected from the group consisting of circles, slots, and combinations thereof.

10. A fuel cell stack having a plurality of cathode air flow spaces formed between cathodes and interconnects thereof, and having at least one baffle for distributing air disposed within a one of said cathode air flow spaces, said baffle including a baffle element having a pattern of perforations for directing air flowing through said cathode air flow space such that temperature variations across a surface area of a cathode adjacent said baffle are minimized.

11. A fuel cell stack in accordance with claim 10 wherein each of said plurality of cathode air flow spaces is provided with a one of said baffle.

12. A fuel cell stack in accordance with claim 10 wherein individual fuel cells thereof are selected from the group consisting of solid oxide fuel cell, proton exchange membrane fuel cell, and direct methanol fuel cell.
